(19) United States
(12) Patent Application Publication
(10) Pub. No.: US 2026/0311171 A1
(43) Pub. Date: Oct. 8, 2026

(54) RANDOMIZED APPLICATION TRANSACTION COUNTER

(71) Applicant: Visa International Service Association, San Francisco, CA (US)

(72) Inventor: Yuexi CHEN, Foster City, CA (US)

(73) Assignee: Visa International Service Association, San Francisco, CA (US)

(21) Appl. No.: 19/481,606

(22) PCT Filed: Jun. 15, 2023
(86) PCT No.: PCT/US2023/068519

§ 371 Date: Nov. 5, 2025

(51) Int. Cl. G06Q 20/38; G06Q 20/34

(52) U.S. Cl. CPC G06Q 20/38215; G06Q 20/341

(57) ABSTRACT

The present disclosure provides devices, systems, and methods for securely conducting payment card transactions based on a randomized application transaction counter (ATC). In one aspect of the present disclosure, a method for implementing a randomized ATC in a payment card transaction can include storing, by a payment card, a first ATC value. The method can further include receiving, by the payment card, a request for a cryptogram from an access device, calculating, by the payment card, a second ATC value by applying the first ATC value to a pseudorandom number generator algorithm, and generating, by the payment card, the cryptogram based on the second ATC value. The method can further include sending, by the payment card, the second ATC value and the cryptogram to the access device. The payment card may store the second ATC value.

### TECHNICAL FIELD

At least some aspects of the present disclosure relate to improving security for payment card (e.g., credit card, debit card) transactions, and more particularly, to improving security related to application transaction counters (ATCs) employed for processing payment card transactions.

### BACKGROUND

Application transaction counters (ATCs) are commonly used in payment card transactions, such as, for example, Europay Mastercard Visa (EMV) transactions. The ATC is a counter that can be maintained by the payment card and used for security-related purposes such as EMV session key diversification, application cryptogram generation, and dynamic data authentication.

Traditionally, the ATC is incrementally and linearly increased (e.g., 0, 1, 2, 3, etc.) each time the payment card is used to carry out a transaction. Each transaction performed using the payment card can therefore have a unique ATC value. Thus, by using the ATC for session key diversification and application cryptogram generation, traditional ATCs can prevent fraudsters from carrying out replay attacks and prevent fraudsters from identifying the payment card's secret symmetric key and asymmetric key using template attacks.

However, due to their incrementally and linearly increasing nature, the use of traditional ATCs can potentially enable fraudsters to identify a stolen payment card's secret symmetric key and asymmetric key using dictionary attacks. For example, a fraudster can precompute a collision database. To do this, the fraudster may generate a list of every possible secret symmetric key for the stolen payment card (e.g., every possible 8-byte key, every possible 16-byte key), select an ATC value (e.g., 306), and diversify every one of the potential secret symmetric keys with the selected ATC value to generate a list of session keys. To complete the collision database, the fraudster may select data for application cryptogram generation (e.g., a transaction amount, a currency code, terminal data) and generate a list of application cryptograms based on the selected data and the list of session keys. Thus, the collision database can be a table that includes a list of secret symmetric keys and a list of corresponding application cryptograms for a given ATC value. The fraudster may then determine the current value of the stolen payment card's ATC (e.g., 56) and conduct dummy transactions to cycle the stolen payment card's ATC until reaching the selected ATC value (e.g., 306) of the collision database. Upon reaching the selected ATC value, the fraudster can cause the payment card to generate an application cryptogram by sending to the payment card the same selected data (e.g., transaction amount, currency code, terminal data) used for the collision database. By identifying a collision (a match) between the cryptogram generated by the card and one of the list of cryptograms in the collision database, the fraudster can look up the stolen payment card's secret symmetric using the collision database. With this information, the fraudster can use the payment card to conduct fraudulent transactions.

Accordingly, there is a need for alternate devices, systems, and methods for securely conducting payment card transactions. The present disclosure provides various solutions that implement randomized ATCs in payment card transactions

### SUMMARY

According to one aspect, the present disclosure provides a method for implementing a randomized application transaction counter (ATC) in a payment card transaction. The method can include storing, by a payment card, a first ATC value. The method can further include receiving, by the payment card, a request for a cryptogram from an access device. The request can be based on a transaction initiated using the payment card and the access device. The method can further include calculating, by the payment card, a second ATC value by applying the first ATC value to a pseudorandom number generator algorithm and generating, by the payment card, the cryptogram based on the second ATC value. The method can further include sending, by the payment card, the second ATC value and the cryptogram to the access device and storing, by the payment card, the second ATC value.

According to another aspect, the present disclosure provides a payment card. The payment card can include a circuit. The circuit can receive a first request for a first cryptogram. The first request can be based on a first transaction initiated using the payment card. The circuit can further determine a first application transaction counter (ATC) value for use with the first transaction and generate the first cryptogram based on the first ATC value. The circuit can further receive a second request for a second cryptogram. The second request can be based on a second transaction initiated using the payment card, wherein the second transaction is the next transaction initiated by the payment card following the first transaction. The circuit can further determine a second ATC value for use with the second transaction, wherein the second ATC value is not determined by incrementally increasing the first ATC value. The circuit can further generate the second cryptogram based on the second ATC value.

According to yet another aspect, the present disclosure provides a method for implementing a randomized application transaction counter (ATC) in a payment card transaction. The method can include storing, by a host server, a first ATC value associated with a payment card. The method can further include receiving, by the host server, a transaction authorization request. The transaction authorization request can include a transaction ATC value. Transaction authorization request can be based on a transaction initiated using the payment card. The method can further include calculating, by the host server, a second ATC value by applying the first ATC value to a pseudorandom number generator algorithm and comparing, by the host server, the transaction ATC value and the second ATC value.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, together with the detailed description below, are incorporated in and form part of the specification, and serve to further illustrate aspects of concepts that include the claimed disclosure and explain various principles and advantages of those aspects.

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a payment network environment, according to at least one aspect of the present disclosure.

FIG. 2 shows a swimlane diagram illustrating a method for implementing a randomized application transaction counter (ATC) in a payment card transaction, wherein the ATC is generated based on a pseudorandom number generator algorithm, according to at least one aspect of the present disclosure.

FIG. 3 shows a swimlane diagram illustrating a method for implementing a randomized application transaction counter (ATC) in a payment card transaction, wherein the ATC is selected from a randomly ordered set of ATCs, according to at least one aspect of the present disclosure.

FIG. 4 is a flow diagram of a method for implementing a randomized application transaction counter (ATC) in a payment card transaction, according to at least one aspect of the present disclosure.

FIG. 5 is a flow diagram of another method for implementing a randomized application transaction counter (ATC) in a payment card transaction, according to at least one aspect of the present disclosure.

FIG. 6 is a flow diagram of yet another method for implementing a randomized application transaction counter (ATC) in a payment card transaction, according to at least one aspect of the present disclosure.

FIG. 7 is a block diagram of a computer apparatus with data processing subsystems or components, according to at least one aspect of the present disclosure.

FIG. 8 is a diagrammatic representation of an example system that includes a host machine, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of the disclosure in any manner.

### DESCRIPTION

Before explaining various forms of the devices, systems, and methods for implementing randomized ATCs, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

As described above, application transaction counters (ATCs) are commonly used in payment card transactions. Traditionally, ATCs are incrementally and linearly increased (e.g., 0, 1, 2, 3, etc.) each time the payment card is used to carry out a transaction. However, due to their incrementally and linearly increasing nature, the use of traditional ATCs can potentially enable fraudsters to identify a stolen payment card's secret symmetric key and asymmetric key, for example, by using dictionary attacks. Accordingly, there is a need for alternate devices, systems, and methods for securely conducting payment card transactions.

The present disclosure provides various devices, systems, and methods that implement randomized ATCs in payment card transactions. In one aspect, the present disclosure provides a method for implementing a randomized ATC in a payment card transaction. According to the method, the payment card can store a first ATC value. The payment card can receive a request for a cryptogram from an access device based on a transaction initiated using the payment card. The payment card can calculate a second ATC value by applying the first ATC value to a pseudorandom number generator algorithm, such as, for example a linear congruential generator algorithm. The payment card can generate the cryptogram based on the second ATC value and send the second ATC value and the cryptogram to the access device. Further, the payment card can store the second ATC value. This method can be repeated for subsequent transactions, calculating the next ATC value based on the most recently stored ATC value, so that a randomized ATC value is used for each transaction.

The devices, systems, and methods provided herein can provide numerous benefits. For example, by implementing randomized ATCs, fraudsters may not be able to use dictionary attacks to identify the secret symmetric key and/or the asymmetric key of a stolen payment card. As described in detail above, executing a dictionary attack can require determining the current value of the stolen payment card's ATC (e.g., 56) and conducting dummy transactions to cycle the stolen payment card's ATC until reaching a selected ATC value (e.g., 306) used to generate a collision database. However, where a randomized ATC is implemented, and an incrementally and linearly increasing ATC value is therefore not implemented, the fraudster may be unable to predictably cycle the stolen payment card's ATC to the selected value. Thus, the fraudster may not be able to cause the payment card to generate a cryptogram for the selected ATC value, thereby preventing the fraudster from implementing the collision database generated based on the selected ATC to identify the stolen card's secret symmetric key. Accordingly, the devices, systems, and methods disclosed herein can provide a specific, nonconventional technological solution to a specific technological problem.

As another example, the devices, systems, and methods provided herein can be employed using existing payment infrastructure, hardware, software, and/or communication protocols. For example, as disclosed herein, a payment card can be configured to calculate a next ATC value by applying a stored ATC value to a pseudorandom number. Using existing EMV protocols, the calculated ATC may be used to diversify a session key, may be used to generate an application cryptogram, and may be communicated to an issuer for validation. Comparatively, other solutions that attempt to address the above-mentioned susceptibly of traditional ATCs to dictionary attacks may include introducing randomness as part of the cryptogram generation. However, this approach may require modifications to existing messaging protocols between the payment card, the access device, the acquirer system, the payment transaction services provider system, and/or the issuer system. Such modifications to existing messaging protocols can require significant and potentially expensive changes to existing payment network infrastructure. Accordingly, the devices, systems, and methods provided herein can provide an improvement to existing technology for payment card transaction security.

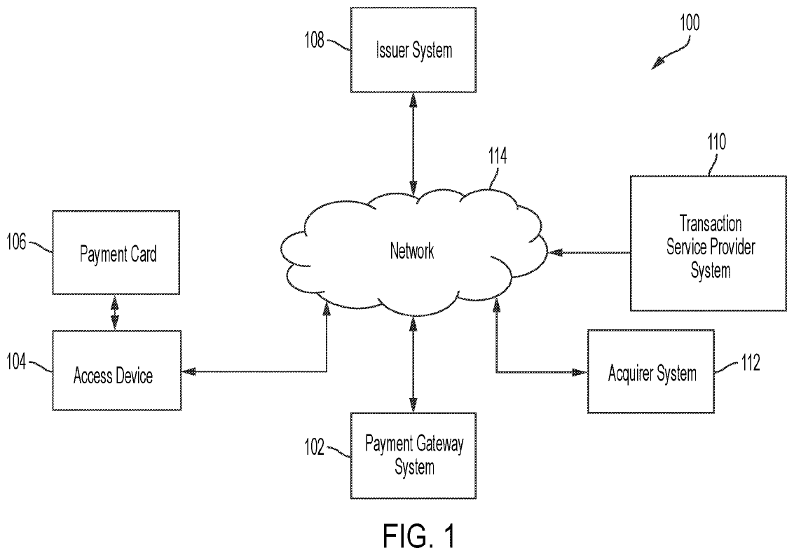

FIG. 1 is a diagram of a payment network environment 100 in which a transaction may be conducted based on a randomized ATC, according to at least one aspect of the present disclosure. As shown in FIG. 1, the payment network environment 100 can include a payment gateway system 102, an access device 104, a payment card 106, an issuer system 108, a transaction service provider system 110, an acquirer system 112, and a network 114. The payment gateway system 102, the access device 104, the issuer system 108, the transaction service provider system 110, and/or the acquirer system 112 may interconnect (e.g., establish a connection to communicate) via wired connections, wireless connections, or a combination of wired and wireless connections.

A “payment network” may refer to an electronic payment system used to accept, transmit, or process transactions made by payment devices for money, goods, or services. The payment network may transfer information and funds among issuers, acquirers, merchants, and payment device users. One illustrative non-limiting example of a payment network is VisaNet, which is operated by Visa, Inc.

A “system” may refer to one or more computing devices or combinations of computing devices (e.g., processors, servers, client devices, software applications, components of such, and/or the like).

Referring again to FIG. 1, the access device 104 may include one or more devices capable of receiving information from and/or transmitting information to the payment gateway system 102, the payment card 106, the issuer system 108, the transaction service provider system 110, and/or the acquirer system 112 via the network 114. The access device 104 may be any suitable device that provides access to a remote system. The access device 104 may also be used for communicating with a merchant computer, a transaction processing computer, an authentication computer, or any other suitable system. The access device 104 device may generally be located in any suitable location, such as at the location of a merchant. The access device 104 device may be in any suitable form. Some examples of the access device 104 can include POS or point-of-sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), kiosks, security systems, access systems, and the like. The access device 104 may use any suitable contact or contactless mode of operation to send or receive data from, or associated with, the payment card 106. For example, the access device 104 may include a reader, a processor, and a computer-readable medium. A reader can include a radio frequency (RF) antenna, an optical scanners, a bar code reader, and/or a magnetic stripe readers to interact with the payment card 106.

As noted above, in some aspects, the access device 104 can comprise a point-of-sale (POS) device. The POS device may include one or more than one device, such a computer, a computer system, a portable electronic device, and/or a peripheral device capable of being used by a merchant to conduct a payment transaction with a user, for example, using the payment card 106. In some aspects, the POS device may be a component of a merchant system associated with a merchant. In some aspects, the POS device can be configured to receive information from the payment card 106 via a communication connection (e.g., a near field communication (NFC) connection, a radio-frequency identification (RFID) communication connection, a Bluetooth® communication connection, and/or the like) and/or transmit information to the payment card 106 via the communication connection.

A “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

A “user” may include an individual. In some embodiments or aspects, a user may be associated with one or more personal accounts, payment cards, and/or portable electronic devices. The user may also be referred to as a cardholder, account holder, or consumer.

Referring again to FIG. 1, the payment card 106 can include any device that may be used to conduct a transaction, such as a financial transaction. For example, a payment card 106 may be used to provide payment information to a merchant. The payment card 106 can include a substrate such as a paper, metal, or plastic card, and information that is printed, embossed, encoded, and/or otherwise included at or near a surface of the payment card. The payment card 106 can be hand-held and compact so that it can fit into a consumer's wallet and/or pocket (e.g., pocket-sized). The payment card 106 can be a smart card, a debit device (e.g., a debit card), a credit device (e.g., a credit card), a stored value device (e.g., a stored value card or “prepaid” card), a magnetic stripe or chip card. The payment card 106 may operate in a contact and/or contactless mode. For example, the payment card 106 may be an electronic payment device, such as a smart card, a chip card, an integrated circuit card, and/or a near field communications (NFC) card, among others. The payment card 106 device may include an embedded integrated circuit. The embedded integrated circuit may include a data storage medium (e.g., volatile and/or non-volatile memory) to store information associated with the payment card 106, such as an account identifier and/or a name of an account holder. The payment card 106 card may interface with the access device 104 to initiate a transaction.

Referring still to FIG. 1, the payment gateway system 102 may include one or more devices capable of receiving information from and/or transmitting information to the access device 104, the issuer system 108, the transaction service provider system 110, and/or the acquirer system 112 via the network 114. For example, the payment gateway system 102 may include a computing device, such as a server (e.g., a transaction processing server), a group of servers, and/or other like devices. The payment gateway system 102 may refer to an entity and/or a payment processing system operated by or on behalf of such an entity (e.g., a merchant service provider, a payment service provider (PSP), a payment facilitator, a payment facilitator that contracts with an acquirer, a payment aggregator, and/or the like), which provides payment services (e.g., transaction service provider payment services, payment processing services, and/or the like) to one or more merchants.

Referring still to FIG. 1, the acquirer system 112 may include one or more devices capable of receiving information from and/or transmitting information to the payment gateway system 102, the access device 104, the issuer system 108, and/or the transaction service provider system 110 via the network 114. For example, the acquirer system 112 may include a computing device, such as a server, a group of servers, and/or other like devices. In some aspects, acquirer system 112 may be associated with an acquirer. In some aspects, the acquirer system 112 may be associated with a merchant account of a merchant associated with the access device 104.

An “acquirer” may refer to an entity licensed by a transaction service provider and/or approved by a transaction service provider to originate transactions (e.g., payment transactions) using a portable financial device associated with the transaction service provider. “Acquirer” or “acquirer system” may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider.

Referring again to FIG. 1, the transaction service provider system 110 may include one or more devices capable of receiving information from and/or transmitting information to the payment gateway system 102, the access device 104, the issuer system 108, and/or the acquirer system 112 via the network 114. For example, the transaction service provider system 110 may include a computing device, such as a server (e.g., a transaction processing server), a group of servers, and/or other like devices. In some aspects, the transaction service provider system 110 may be associated with a transaction service provider. In some aspects, transaction service provider system 110 may be in communication with a data storage device, which may be local or remote to the transaction service provider system 110. In some aspects, the transaction service provider system 110 may be capable of receiving information from, storing information in, transmitting information to, or searching information stored in a data storage device.

A “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting aspects, a transaction service provider system may include one or more server computers with one or more processors and, in some non-limiting aspects, may be operated by or on behalf of a transaction service provider.

Referring again to FIG. 1, the issuer system 108 may include one or more devices capable of receiving information from and/or transmitting information to payment gateway system 102, the access device 104, transaction service provider system 110, and/or the acquirer system 112 via the network 114. For example, issuer system 108 may include a computing device, such as a server, a group of servers, and/or other like devices. In various aspects, the issuer system 108 may be associated with an issuer institution. For example, the issuer system 108 may be associated with an issuer institution that issued a credit account, debit account, credit card account, debit card account, and/or the like to a user associated with the payment card 106.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. As used herein “issuer system” or “issuer institution system” may refer to one or more systems operated by or operated on behalf of an issuer. For example, an issuer system may refer to a server executing one or more software applications associated with the issuer. In some non-limiting aspects of the present disclosure, an issuer system may include one or more servers (e.g., one or more authorization servers) for authorizing a payment transaction. An “issuer” can include a payment account issuer. The payment account (which may be associated with one or more payment devices) may refer to any suitable payment account (e.g., credit card account, a checking account, a savings account, a merchant account assigned to a consumer, or a prepaid account), an employment account, an identification account, an enrollment account (e.g., a student account), etc.

Referring again to FIG. 1, the network 114 may include one or more wired and/or wireless networks. For example, the network 114 may include a cellular network (e.g., a long-term evolution (LTE) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices, systems, and networks shown in the payment network environment 100 of FIG. 1 are provided as an example. There may be additional devices, systems, and/or networks, fewer devices, systems, and/or networks, different devices, systems, and/or networks, or differently arranged devices, systems, and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of the payment network environment 100 may perform one or more functions described as being performed by another set of devices of the payment network environment 100.

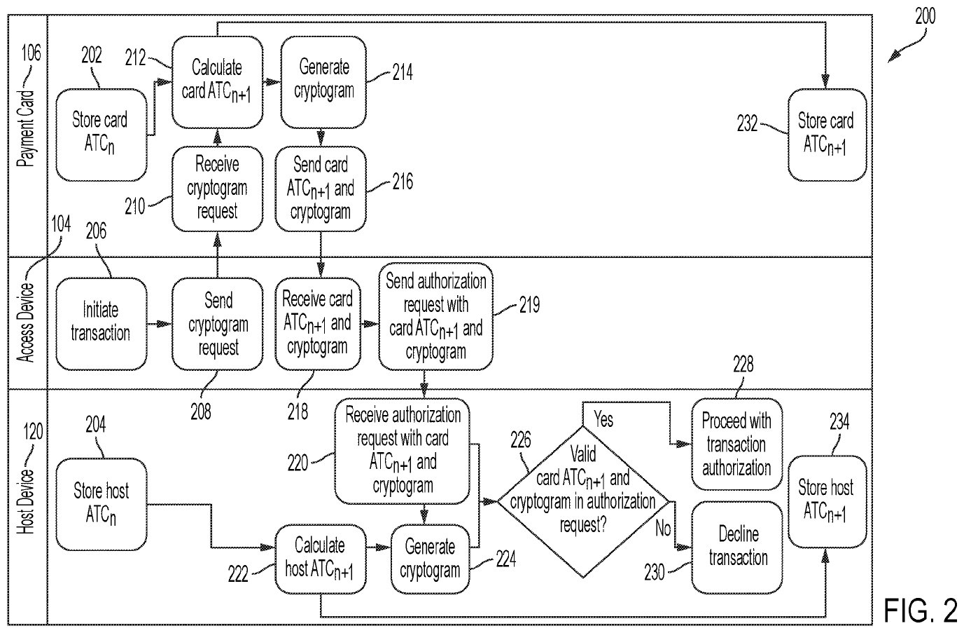

FIG. 2 is a swimlane diagram illustrating a method 200 for implementing a randomized application transaction counter (ATC) in a payment card transaction, according to at least one aspect of the present disclosure. The method 200 can be carried out across the payment network environment 100 (FIG. 1). For example, the method 200 may be implemented using the payment card 106, the access device 104, and a host device 120. In some aspects, the host device 120 may be comprised in the issuer system 108. In other aspects, the host device 120 may be comprised in the transaction service provider system 110.

Referring primarily to FIG. 2, and also to FIG. 1, the payment card 106 can store 202 a card ATCₙ and the host device can store 204 a host ATCₙ. In some aspects, the card ATCₙ and the host ATCₙ may be a two-byte hexadecimal value in a range of 0x0000 to 0x7FFF (e.g., with a corresponding decimal integer value in a range of 0 to 32767). In other aspects, the card ATCₙ and the host ATCₙ may be a two-byte hexadecimal value in a range of 0x0000 to 0xFFFF (e.g., with a corresponding decimal value integer in a range of 0 to 65535).

The card ATCₙ and the host ATCₙ have the same value. For example, upon issuance of the payment card 106 (e.g., by an issuer associated with the host device 120) an initial ATC (card ATCₙ₌₀) may be designated to the payment card 106 and stored 202 on a memory of the payment card 106. The same initial ATC (host ATCₙ₌₀) may be stored 204 on a memory of the host device 120 and associated with a PAN of the payment card 106. The initial ATC (card ATCₙ₌₀=host ATCₙ₌₀) may be a randomly generated value.

Referring still primarily to FIG. 2, and also to FIG. 1, according to the method 200, the access device 104 may initiate 206 a transaction based on an interaction with the payment card 106. For example, the access device 104 may initiate 206 the transaction based on the payment card 106 interacting with a card reader of the access device 104 (e.g., as the result of a user tapping the card proximate to the card reader or dipping the card into the card reader). Based on initiating 206 the transaction, the access device 104 can send 208 a request for a cryptogram (e.g., an application cryptogram) to the payment card 106. The payment card 106 can receive 210 the request for the cryptogram from the access device 104.

Based on receiving 210 the request, the payment card 106 can calculate 212 a next card ATCₙ₊₁ based on the stored 202 card ATCₙ. The next card ATCₙ₊₁ can be calculated 212 by applying the stored 202 card ATC, to a pseudorandom number generator algorithm. Thus, rather than choosing the next card ATCₙ₊₁ by incrementally increasing the stored ATCₙ (e.g., 0, 1, 2, 3, 4, etc.), the value of the next card ATCₙ₊₁ can be a random value that is calculated 212 by the pseudorandom number generator algorithm (4556, 51131, 92, 3001, 781, etc.).

In some aspects, the pseudorandom number generator algorithm used to calculate 212 the next card ATCₙ₊₁ based on the stored 202 card ATCₙ can be a linear congruential generator (LCG) algorithm. The LCG algorithm may be defined by the following function:

$${X}_{n + 1} = ( a {X}_{n} + c ) mod m$$

In the above function, each of the parameters a, c, and m are constants. Those of ordinary skill in the art will understand that a, c, and m can be selected to ensure that each calculated value of Xₙ₊₁ is random with respect to Xₙ. The above function can be used to randomly calculate 212 next card ATCₙ₊₁ based on the stored 202 card ATCₙ, as shown below:

$$A T {C}_{n + 1} = ( {aATC}_{n} + c ) mod m$$

In some aspects, an entity associated with the host device 120 (e.g., an issuer associated with the host device 120) can select the parameters a, c, and m to be used by the LCG algorithm.

Referring still primarily to FIG. 2, and also to FIG. 1, the payment card 106 can generate 214 a cryptogram (e.g., an application cryptogram) based on the card ATCₙ₊₁. In some aspects, the cryptogram can be generated 214 according to existing Europay Mastercard Visa (EMV) standards, except that the randomly determined card ATCₙ₊₁ is used. For example, a master key may be stored by the payment card 106. A session key may be derived for the transaction by diversifying the master key with the card ATCₙ₊₁. The session key may then be applied to a cryptographic algorithm (e.g., a Triple Data Encryption Standard (3DES) algorithm) to generate the cryptogram.

Referring still primarily to FIG. 2, and also to FIG. 1, the payment card 106 can send 216 the calculated 212 card ATCₙ₊₁ and the generated 214 cryptogram to the access device 104. The access device 104 can receive 218 the card ATCₙ₊₁ and the cryptogram and send 219 a transaction authorization request comprising the card ATCₙ₊₁ and the cryptogram to the host device 120. The host device 120 can receive 220 the transaction authorization request comprising the card ATCₙ₊₁ and the cryptogram. In some aspects, the transaction authorization request may be communicated through one or more intermediaries (e.g., the payment gateway system 102, the acquirer system 112, and/or the transaction service provider system 110) between being sent 219 by the access device 104 and received 220 by the host device 120.

Referring still primarily to FIG. 2, and also to FIG. 1, as noted above, the host device 120 can store 204 a host ATCₙ that is the same value as the card ATCₙ stored 202 by the payment card 106. Using the same technique employed by the payment card 106 to calculate 212 the next card ATCₙ₊₁ based on the stored 202 card ATCₙ, the host device 120 can calculate 222 the next host ATCₙ₊₁ based on the stored 204 host ATCₙ. For example, the host device 120 can calculate 222 the next host ATCₙ₊₁ using the same pseudorandom number generator algorithm, with the same parameters, as is used by the payment card 106 to calculate 212 the next card ATCₙ₊₁. Accordingly, both the next card ATCₙ₊₁ calculated 212 by the payment card 106 and the next host ATCₙ₊₁ calculated 222 by the host device 120 can be the same value.

Referring still primarily to FIG. 2, and also to FIG. 1, the host device 120 can generate 224 a cryptogram based on the host ATCₙ₊₁. The host device 120 can generate 224 the cryptogram based on the host ATCₙ₊₁ using the same technique employed by the payment card 106 to generate 214 the cryptogram based on the card ATCₙ₊₁. For example, the host device 120 may determine a master key corresponding to the payment card 106. The host device 120 can derive a session key by diversifying the master key with the host ATCₙ₊₁. The host device 120 may then apply the session key to a cryptographic algorithm to generate the cryptogram.

Referring still primarily to FIG. 2, and also to FIG. 1, the host device 120 can determine 226 whether the card ATCₙ₊₁ and the cryptogram included in the received 220 authorization request are valid. The host device 120 can perform this validation by comparing the card ATCₙ₊₁ to the host ATCₙ₊₁ and by comparing the cryptogram included in the authorization request to the cryptogram generated 224 by the host device 120. If the card ATCₙ₊₁ and the host ATCₙ₊₁ match and the cryptograms match, then the host device 120 may proceed 228 with the transaction authorization according to existing methods (e.g., determining whether the account associated with the payment card 106 has sufficient funds for the transaction, etc.). However, if the card ATCₙ₊₁ and the host ATCₙ₊₁ do not match, then the card ATCₙ₊₁ may be invalid. Similarly, if the cryptogram included in the authorization request does not match the cryptogram generated 224 by the host device 120, then the cryptogram included in the authorization request may be invalid. An invalid card ATCₙ₊₁ and/or an invalid cryptogram can indicate that a fraudster is attempting to conduct a fraudulent transaction using stolen information from the payment card 106. Where the host device 120 determines 226 that the card ATCₙ₊₁ and/or the cryptogram included in the authorization request are invalid, the host device 120 may decline 230 the transaction.

Referring still primarily to FIG. 2, and also to FIG. 1, the payment card 106 may store 232 the calculated 212 card ATCₙ₊₁. For a next transaction using the payment card 106, the payment card 106 may retrieve the stored 232 card ATCₙ₊₁ for the calculation of yet a next card ATCₙ₊₂. For example, the stored 232 card ATCₙ₊₁ may replace the stored 202 card ATC, and the method 200 may be repeated as described herein for the next transaction using the payment card 106.

Similarly, the host device 120 may store 234 the calculated 222 host ATCₙ₊₁. For a next transaction authorization request received 220 based on a next transaction using the payment card 106, the host device 120 may retrieve the stored 234 host ATCₙ₊₁ for the calculation of yet a next host ATCₙ₊₂. For example, the stored 234 host ATCₙ₊₁ may replace the stored 204 ATC, and the method 200 may be repeated as described herein for the next transaction using the payment card 106. Thus, this method 200 may be repeated every time the payment card 106 is used to conduct a transaction, with a next card ATCₙ₊₁ and a next host ATCₙ₊₁ having the same value being randomly generated for each transaction.

According to some aspects of the method 200, the transaction initiated 206 by the access device 104 may be an online transaction. Where the transaction is an online transaction, the method 200 may generally proceed as described above, for example.

According to other aspects of the method 200, the transaction initiated 206 by the access device 104 may be an offline transaction with deferred authorization. For example, the transaction initiated 206 by the access device 104 may be a first offline transaction. The payment card 106 may calculate 212 a first card ATCₙ₊₁ for the first offline transaction. Following the first offline transaction, the payment card 106 may be used to conduct a second offline transaction (or an online transaction) and may calculate 212 a second card ATCₙ₊₂ for the second offline transaction. The host device 120 may receive 220 the transaction authorization request for the second offline transaction (including the second card ATCₙ₊₂) prior to receiving 220 the transaction authorization request for the first offline transaction (including the first card ATCₙ₊₁).

In order to be able to validate card ATCs for multiple offline transactions (and/or a mix of online and offline transactions) that may be received 220 in a different order than the transactions were initiated 206, according to some aspects of the method 200, calculating 222 the next host ATCₙ₊₁ can include calculating a set of next host ATC values (e.g., host ATCₙ₊₁, host ATCₙ₊₂, . . . . ATCₙ₊ₖ). Each host ATC in the set may be calculated by sequentially applying an output host ATC value calculated by the pseudorandom number generator algorithm as an input host ATC value for calculating a next ATC value of the set of ATC values until a predetermined number (k) of ATC values is calculated. The predetermined number of ATC values calculated for the set can be selected based on a desired window size for deferred authorization. In this aspect, determining 226 whether the first card ATCₙ₊₁ in the transaction authorization request for the first transaction is valid can include comparing the first card ATCₙ₊₁ to the set of host ATC values. Similarly, determining 226 whether the second card ATCₙ₊₂ in the transaction authorization request for the second transaction is valid can include comparing the second card ATCₙ₊₂ to the set of host ATC values. In each case, the host device 120 can determine that the card ATC is valid, even if the second card ATCₙ₊₂ is received before the first card ATCₙ₊₁, because both the first card ATCₙ₊₁ and the second card ATCₙ₊₂ are included in the set of host ATC values.

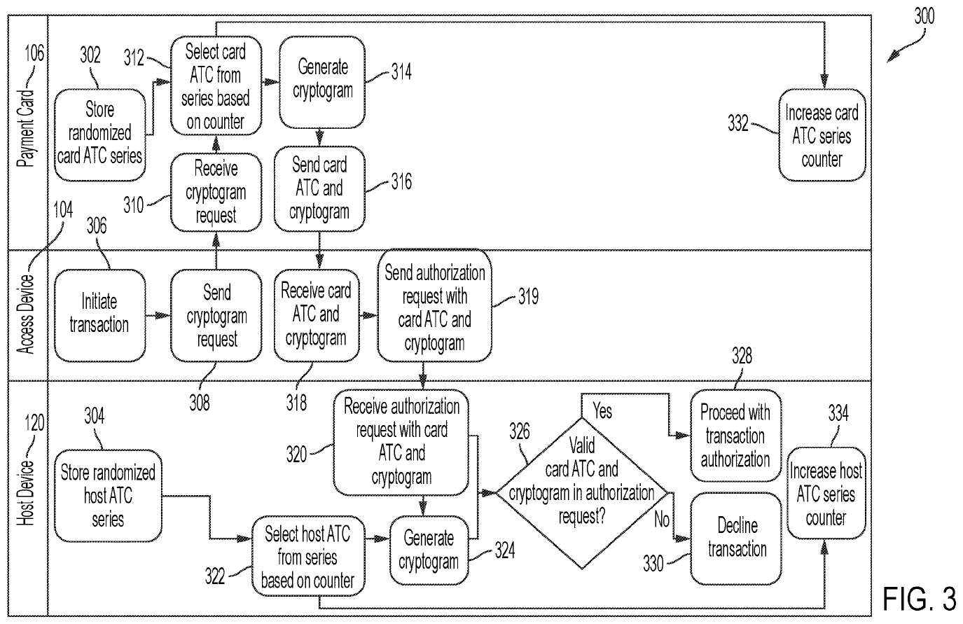

FIG. 3 shows a swimlane diagram illustrating a method 300 for implementing a randomized application transaction counter (ATC) in a payment card transaction, according to at least one aspect of the present disclosure. The method 300 can be similar to the method 200 (FIG. 2) in many respects. Any of the aspects of the method 200 described herein can be applied to the method 300 and vice versa. The method 300 can be carried out across the payment network environment 100 (FIG. 1) and may be implemented using the payment card 106, the access device 104, and a host device 120.

Referring primarily to FIG. 3, and also to FIG. 1, the payment card 106 can store 302 a randomized series of card ATC values and the host device can store 304 a randomized series of host ATC values. In some aspects, each of card ATC in the series of card ATC values and each host ATC in the series of host ATC values may be a two-byte hexadecimal value in a range of 0x0000 to 0x7FFF (e.g., with a corresponding decimal integer value in a range of 0 to 32767). In other aspects, each card ATC in the series of card ATC values and each host ATC in the series of host ATC values may be a two-byte hexadecimal value in a range of 0x0000 to 0xFFFF (e.g., with a corresponding decimal value integer in a range of 0 to 65535).

The randomized series of card ATC values stored 302 by the payment card 106 and the randomized series of host ATC values stored 304 by the host device 120 can be the same series of ATC values stored the same order. For example, upon issuance of the payment card 106 (e.g., by an issuer associated with the host device 120), a unique randomized series of ATC values may be generated for the payment card 106. In one aspect, the randomized series of card ATC values may be generated by selecting an ordered sequence of ATC values (e.g., 0, 1, 2, 3, 4 . . . 65534, 65535) and applying the ordered sequence to a shuffle algorithm, such as Fisher-Yates shuffle algorithm, to randomize the sequence (e.g., 4556, 51131, 92 . . . 3001, 781). The randomized series of ATC values can be designated to the payment card 106 and stored 302 on a memory of the payment card 106 as the randomized series of card ATC values. The same randomized series of ATC values may be stored 304 on a memory of the host device 120 as the randomized series of host ATC values and associated with a PAN of the payment card 106. A different randomized series of ATC values can be generated for each payment card 106 that is issued.

Referring still primarily to FIG. 3, and also to FIG. 1, according to the method 300, the access device 104 may initiate 306 a transaction based on an interaction with the payment card 106. Based on initiating 306 the transaction, the access device 104 can send 308 a request for a cryptogram (e.g., an application cryptogram) to the payment card 106. The payment card 106 can receive 310 the request for the cryptogram from the access device 104.

Based on receiving 310 the request, the payment card 106 can select 312 a next card ATC from the series of randomized card ATC values stored 302 by the card. This selection can be performed based on a counter that is increased 332 each time a transaction is carried out using the payment card 106. Thus, rather than choosing the next card ATC based on an ordered sequence of ATC values (e.g., 0, 1, 2, 3, 4, etc.), the value of the next card ATC can be a random value selected from a randomized sequence of ATC values (e.g., 4556, 51131, 92 . . . 3001, 781).

Referring still primarily to FIG. 3, and also to FIG. 1, the payment card 106 can generate 314 a cryptogram (e.g., an application cryptogram) based on the selected 312 card. In some aspects, the cryptogram can be generated 314 according to existing Europay Mastercard Visa (EMV) standards, except that the card ATC used to generate 314 the cryptogram is selected 312 from a randomize sequence of ATC values rather than an ordered sequence of ATC values. For example, a master key may be stored by the payment card 106. A session key may be derived for the transaction by diversifying the master key with the selected 312 card ATC. The session key may then be applied to a cryptographic algorithm (e.g., a Triple Data Encryption Standard (3DES) algorithm) to generate the cryptogram.

Referring still primarily to FIG. 3, and also to FIG. 1, the payment card 106 can send 316 the selected 312 card ATC and the generated 314 cryptogram to the access device 104. The access device 104 can receive 318 the card ATC and the cryptogram and send 319 a transaction authorization request comprising the card ATC and the cryptogram to the host device 120. The host device 120 can receive 320 the transaction authorization request comprising the card ATC and the cryptogram. In some aspects, the transaction authorization request may be communicated through one or more intermediaries (e.g., the payment gateway system 102, the acquirer system 112, and/or the transaction service provider system 110) between being sent 319 by the access device 104 and received 320 by the host device 120.

Referring still primarily to FIG. 3, and also to FIG. 1, as noted above, the host device 120 can store 304 a randomized series of host ATC values that is the same the randomized series of card ATC values stored 302 by the payment card 106. The host device 120 can maintain a counter that is increased 334 every time it processes a transaction from the payment card 106. As valid transactions are processed, the payment card 106 increases its counter and the host device 120 increases 334 its counter such that the counters correspond to one another. The host device 120 can select 322 a host ATC from the stored 304 series of randomized host ATC values based on the host device 120 counter. Where a valid transaction is being processes, the host ATC selected 322 by the host device 120 matches the card ATC selected 312 by the payment card.

Referring still primarily to FIG. 3, and also to FIG. 1, the host device 120 can generate 324 a cryptogram based on the selected 322 host ATC. The host device 120 can generate 324 the cryptogram based on the selected 322 host ATC using the same technique employed by the payment card 106 to generate 314 the cryptogram based on the selected 312 card ATC.

Referring still primarily to FIG. 3, and also to FIG. 1, the host device 120 can determine 326 whether the card ATC and the cryptogram included in the received 320 authorization request are valid. The host device 120 can perform this validation by comparing the card ATC to the host ATC and by comparing the cryptogram included in the authorization request to the cryptogram generated 324 by the host device 120. If the card ATC and the host ATC match and the cryptograms match, then the host device 120 may proceed 328 with the transaction authorization according to existing methods (e.g., determining whether the account associated with the payment card 106 has sufficient funds for the transaction, etc.). However, if the card ATC and the host ATC do not match, then the card ATC may be invalid. Similarly, if the cryptogram included in the authorization request does not match the cryptogram generated 324 by the host device 120, then the cryptogram included in the authorization request may be invalid. An invalid card ATC and/or an invalid cryptogram can indicate that a fraudster is attempting to conduct a fraudulent transaction using stolen information from the payment card 106. Where the host device 120 determines 326 that the card ATC and/or the cryptogram included in the authorization request are invalid, the host device 120 may decline 330 the transaction.

Referring still primarily to FIG. 3, and also to FIG. 1, as noted above, the payment card 106 can increase 332 a card ATC series counter every time the payment card 106 is used to conduct a transaction and the host device 120 can increase 334 a host ATC series counter every time the host device 120 processes a transaction corresponding to the payment card 106. Thus, to carry out a next transaction using the payment card 106, the method 300 may be repeated as described above, where the payment card 106 will select 312 the next card ATC from the randomized series of card ATC values and the host device 120 will select 322 a corresponding next host ATC from the randomized shears of host ATC values.

According to some aspects of the method 300, the transaction initiated 306 by the access device 104 may be an online transaction. Where the transaction is an online transaction, the method 300 may generally proceed as described above, for example.

According to other aspects of the method 300, the transaction initiated 306 by the access device 104 may be an offline transaction with deferred authorization. For example, the transaction initiated 206 by the access device 104 may be a first offline transaction. In order to be able to validate card ATCs for multiple offline transactions (and/or a mix of online and offline transactions) that may be received 320 in a different order than the transactions were initiated 306, according to some aspects of the method 300, selecting 322 a host ATC from the randomized series of host ATC values can include selecting a predetermined number (k) of the next host ATC values in the series. The predetermined number (k) of ATC values can be selected based on a desired window size for deferred authorization. In this aspect, determining 326 whether the card ATC in the transaction authorization request for an offline transaction valid can include comparing the card ATC to the predetermined number (k) of the next host ATC values in the series. This can enable the host device 120 to validate transaction authorization requests for offline transactions that may be received 320 in a different order than the transactions were initiated 306.

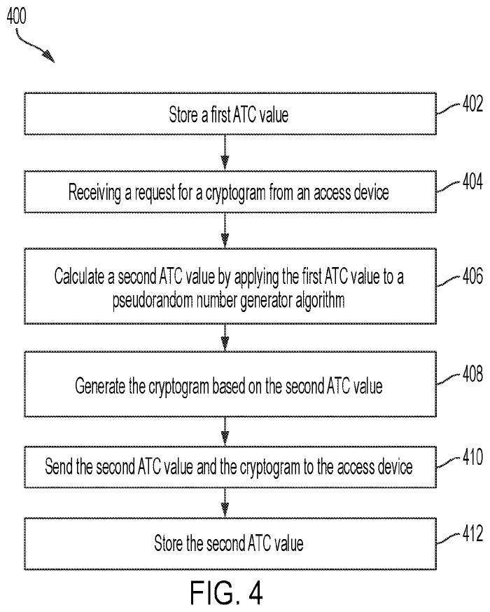

FIG. 4 is a flow diagram of a method 400 for implementing a randomized application transaction counter (ATC) in a payment card transaction, according to at least one aspect of the present disclosure. The method 400 can be similar to the method 200 (FIG. 2) in many respects. Any of the aspects of the method 200 described herein can be applied to the method 400 and vice versa. In some aspects, the method 300 can be carried by the payment card 106 communicating with the access device 104.

Referring primarily to FIG. 4, and also to FIG. 1, according to the method 400, the payment card 106 can store 402 a first ATC value. The payment card 106 can receive 404 a request for a cryptogram from the access device 104. The request for the cryptogram may be based on a transaction initiated using the payment card 106 and the access device 104. The payment card 106 can calculate 406 a second ATC value by applying the first ATC value to a pseudorandom number generator algorithm and generate 408 the cryptogram based on the second ATC value. Further, the payment card 106 can send 410 the second ATC value and the cryptogram to the access device. The payment card 106 can store 412 the second ATC value.

According to one aspect of the method 400, the payment card 106 can calculate 406 the second ATC value by applying the first ATC value to a linear congruential generator algorithm.

According to one aspect of the method 400, the first ATC value is stored 402 by the payment card based on an issuance of the payment card by an issuer (e.g., an issuer associated with the issuer system 108 (FIG. 1)).

According to one aspect of the method 400, the request received 404 by the payment card 106 is a first request, the transaction corresponding to the request is a first transaction, and the cryptogram generated 408 by the payment card 106 is a first cryptogram. Further, the access device 104 can be a first access device. In this aspect, according to the method 400, the payment card 106 can receive a second request for a second cryptogram from a second access device. The second request can be based on a second transaction initiated using the payment card 106 and the second access device. The payment card 106 can calculate a third ATC value by applying the second ATC value to the pseudorandom number generator algorithm and generate the second cryptogram based on the third ATC value. The payment card 106 can send the third ATC value and the second cryptogram to the second access device. Further, the payment card 106 can store the third ATC value.

According to one aspect of the method 400, the payment card 106 can generate 408 the cryptogram based on the second ATC value by diversifying a session key based on the second ATC value and generating the cryptogram based on the session key.

According to one aspect of the method 400, the transaction is an online transaction. Further, generating 408 the cryptogram based on the second ATC value can include generating an authorization request cryptogram (ARQC).

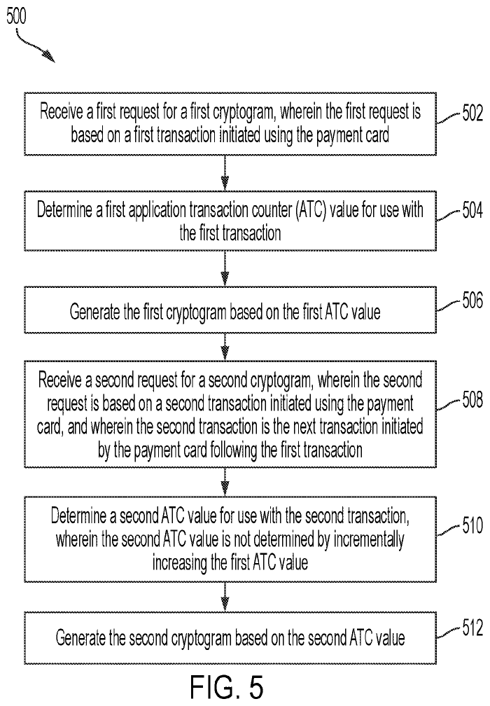

FIG. 5 is a flow diagram of method 500 for implementing a randomized application transaction counter (ATC) in a payment card transaction, according to at least one aspect of the present disclosure. The method 500 can be similar to the method 200 (FIG. 2) in many respects and/or may be similar to the method 300 (FIG. 3) in many respects. Any of the aspects of the method 200 and/or the method 300 described herein can be applied to the method 500 and vice versa. In some aspects, the method 500 can be carried out by a circuit of the payment card 106 communicating with the access device 104.

Referring primarily to FIG. 5, and also to FIG. 1, according to the method 500, the payment card 106 can receive 502 a first request for a first cryptogram. The first request can be based on a first transaction initiated using the payment card 106. The payment card 106 can determine 504 a first ATC value for use with the first transaction and generate 506 the first cryptogram based on the first ATC value. Further, the payment card 106 can receive 508 a second request for a second cryptogram. The second request can be based on a second transaction initiated using the payment card 106. The second transaction can be the next transaction initiated by the payment card 106 following the first transaction. The payment card 106 determine 510 a second ATC value for use with the second transaction and generate 512 the second cryptogram based on the second ATC value. The second ATC value is not determined by incrementally and/or linearly increasing the first ATC value.

According to one aspect of the method 500, the payment card 106 can apply the first ATC value to a pseudorandom number generator algorithm to determine 510 the second ATC value. The pseudorandom number generator algorithm can be a linear congruential generator algorithm, for example.

According to one aspect of the method 500, the payment card 106 can store an initial ATC value. The initial ATC value may be provided by an issuer (e.g., an issuer associated with the issuer system 108) of the payment card 106 based on issuing the payment card 106. The payment card 106 can apply the initial ATC value to a pseudorandom number generator algorithm to determine 504 the first ATC value.

According to one aspect of the method 500, the payment card can store a randomized series of ATC values. The randomized series of ATC values can include the first ATC value and the second ATC value. The randomized series of ATC values may be provided by an issuer (e.g., an issuer associated with the issuer system 108) of the payment card 106 based on issuing the payment card 106. The randomized series of ATC values may be randomized based on a Fisher-Yates shuffle algorithm, for example.

According to one aspect of the method 500, the payment card 106 comprises a circuit is configured according to a Europay Mastercard Visa (EMV) standard.

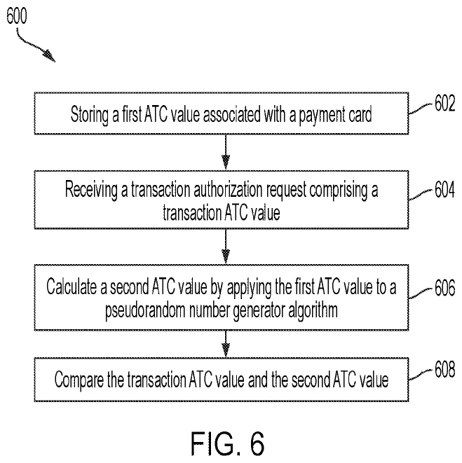

FIG. 6 is a flow diagram of a method 600 for implementing a randomized application transaction counter (ATC) in a payment card transaction, according to at least one aspect of the present disclosure. The method 600 can be similar to the method 200 (FIG. 2) in many respects. Any of the aspects of the method 200 described herein can be applied to the method 600 and vice versa. In some aspects, the method 600 can be carried by an issuer system 108. In other aspects, the method 600 can be carried out by a transaction service provider system 110 rather than the issuer system 108 described below. The issuer system 108 and/or the transaction service provider system 110 can sometimes be referred to as a host device 120.

Referring primarily to FIG. 6, and also to FIG. 1, according to the method 600, the issuer system 108 can store 602 a first ATC value associated with the payment card 106. The issuer system 108 can receive 604 a transaction authorization request. The transaction authorization request can include a transaction ATC value. The transaction authorization request can be based on a transaction initiated using the payment card 106. The issuer system 108 can calculate 606 a second ATC value by applying the first ATC value to a pseudorandom number generator algorithm. Further, the issuer system 108 can compare 608 the transaction ATC value and the second ATC value.

According to one aspect of the method 600, the issuer system 108 can authorize the transaction based on the transaction ATC value matching the second ATC value. In another aspect of the method 600, the issuer system 108 can decline the transaction based on the transaction ATC value not matching the second ATC value.

According to one aspect of the method 600, the issuer system can store the second ATC value.

According to one aspect of the method 600, the transaction authorization request received 604 by the issuer system 108 can further include a cryptogram generated based on the transaction ATC value. In this aspect, the issuer system 108 can generate a session key based on the transaction ATC value and validate the cryptogram based on the session key.

According to one aspect of the method 600, the transaction is an offline transaction and the transaction authorization request received 604 by the issuer system 108 is a deferred authorization request. In this aspect, the issuer system 108 can calculate a set of ATC values. The set of ATC values includes a predetermined number of ATC values. Calculating the set of ATC values can include sequentially applying an output ATC value calculated by the pseudorandom number generator algorithm as an input ATC value for calculating a next ATC value of the set of ATC values until the predetermined number of ATC values is calculated. Further, the issuer system 108 can compare the transaction ATC value to the set of ATC values. The issuer system 108 can authorize the deferred authorization request based on the transaction ATC value matching one ATC value from the set of ATC values.

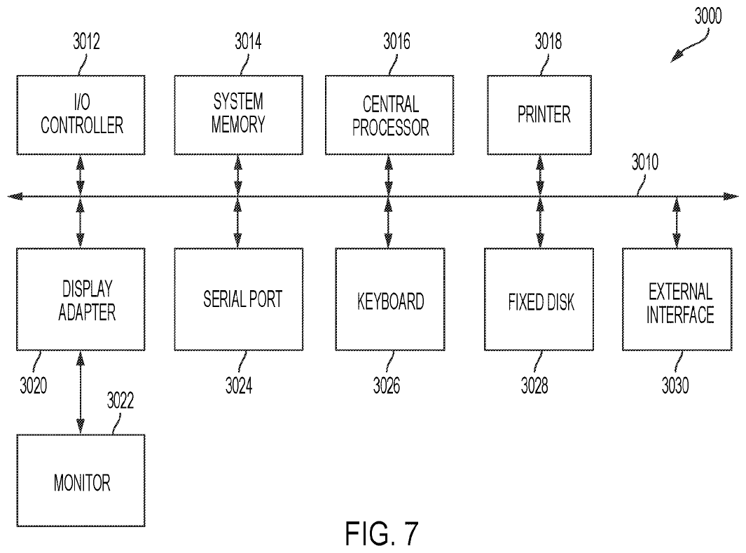

FIG. 7 is a block diagram of a computer apparatus 3000 comprising data processing subsystems or components, according to at least one aspect of the present disclosure. The subsystems shown in FIG. 7 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

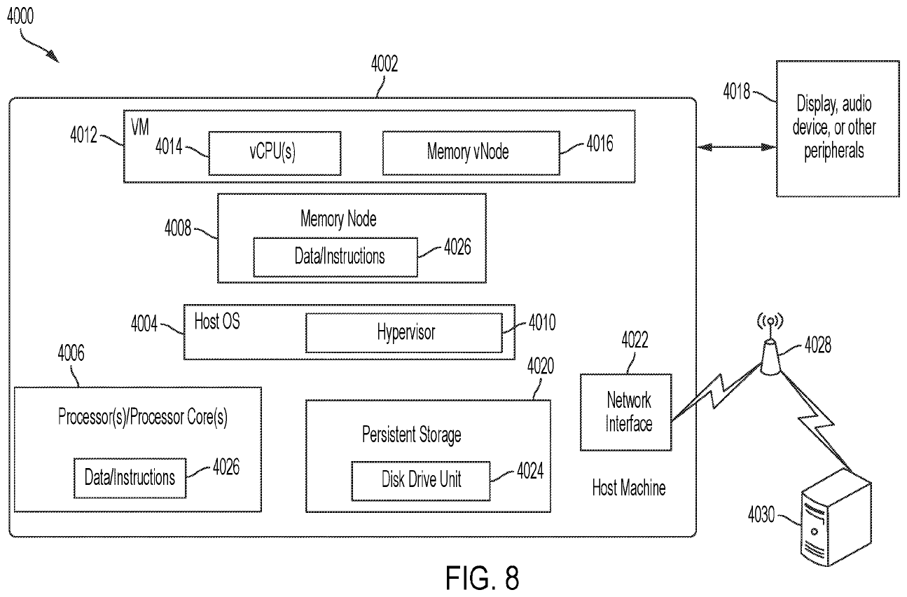

FIG. 8 is a diagrammatic representation of an example computing system 4000 that includes a host machine 4002 within which a set of instructions to perform various aspects any one or more of the methodologies discussed herein may be executed, such as, for example, the method 200 of FIG. 2, the method 300 of FIG. 3, and the method 600 of FIG. 6, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 4002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (“VM”) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to the corresponding vNode 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AlN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4028 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A “key” may refer to a piece of information that is used in a cryptographic algorithm to transform input data into another representation.

A “cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

Examples of the devices, systems, and methods according to various aspects of the present disclosure are provided below in the following numbered clauses. An aspect of any of the devices(s), method(s) and/or system(s) may include any one or more than one, and any combination of, the numbered clauses described below.

Clause 1: A method for implementing a randomized application transaction counter (ATC) in a payment card transaction, the method comprising: storing, by a payment card, a first ATC value; receiving, by the payment card, a request for a cryptogram from an access device, wherein the request is based on a transaction initiated using the payment card and the access device; calculating, by the payment card, a second ATC value by applying the first ATC value to a pseudorandom number generator algorithm; generating, by the payment card, the cryptogram based on the second ATC value; sending, by the payment card, the second ATC value and the cryptogram to the access device; and storing, by the payment card, the second ATC value.

Clause 2: The method of Clause 1, wherein calculating the second ATC value by applying the first ATC value to the pseudorandom number generator algorithm comprises applying the first ATC value to a linear congruential generator algorithm.

Clause 3: The method of any of Clauses 1-2, where the first ATC value is stored by the payment card based on an issuance of the payment card by an issuer.

Clause 4: The method of any of Clauses 1-3, wherein the request is a first request, wherein the transaction is a first transaction, wherein the cryptogram is a first cryptogram, and wherein the access device is a first access device, the method further comprising: receiving, by the payment card, a second request for a second cryptogram from a second access device, wherein the second request is based on a second transaction initiated using the payment card and the second access device; calculating, by the payment card, a third ATC value by applying the second ATC value to the pseudorandom number generator algorithm; generating, by the payment card, the second cryptogram based on the third ATC value; sending, by the payment card, the third ATC value and the second cryptogram to the second access device; and storing, by the payment card, the third ATC value.

Clause 5: The method of any of Clauses 1-3, wherein generating, by the payment card, the cryptogram based on the second ATC value comprises: diversifying, by the payment card, a session key based base on the second ATC value; and generating, by the payment card, the cryptogram based on the session key.

Clause 6: The method of Clauses 1-3, wherein the transaction is an online transaction, and wherein generating the cryptogram based on the second ATC value comprises generating an authorization request cryptogram (ARQC).

Clause 7: A payment card, comprising: a circuit to: receive a first request for a first cryptogram, wherein the first request is based on a first transaction initiated using the payment card; determine a first application transaction counter (ATC) value for use with the first transaction; generate the first cryptogram based on the first ATC value; receive a second request for a second cryptogram, wherein the second request is based on a second transaction initiated using the payment card, and wherein the second transaction is the next transaction initiated by the payment card following the first transaction; determine a second ATC value for use with the second transaction, wherein the second ATC value is not determined by incrementally increasing the first ATC value; and generate the second cryptogram based on the second ATC value.

Clause 8. The payment card of Clause 7, wherein the circuit is to: apply the first ATC value to a pseudorandom number generator algorithm to determine the second ATC value.

Clause 9: The payment card of Clause 8, wherein the pseudorandom number generator algorithm is a linear congruential generator algorithm.

Clause 10: The payment card of any of Clauses 8-9, wherein the circuit is further to: store an initial ATC value, wherein the initial ATC value is provided by an issuer of the payment card based on issuing the payment card; and apply the initial ATC value to the pseudorandom number generator algorithm to determine the first ATC value.

Clause 11: The payment card of Clause 7, wherein the circuit is to: store a randomized series of ATC values, wherein the randomized series of ATC values includes the first ATC value and the second ATC value, and wherein the randomized series of ATC values is provided by an issuer of the payment card based on issuing the payment card.

Clause 12: The payment card of Clause 11, wherein the randomized series of ATC values is randomized based on a Fisher-Yates shuffle algorithm.

Clause 13: The payment card of any of Clause 7-12, wherein the circuit is configured according to a Europay Mastercard Visa (EMV) standard.

Clause 14: A method for implementing a randomized application transaction counter (ATC) in a payment card transaction, the method comprising: storing, by a host server, a first ATC value associated with a payment card; receiving, by the host server, a transaction authorization request, wherein the transaction authorization request comprises a transaction ATC value, and wherein the transaction authorization request is based on a transaction initiated using the payment card; calculating, by the host server, a second ATC value by applying the first ATC value to a pseudorandom number generator algorithm; and comparing, by the host server, the transaction ATC value and the second ATC value.

Clause 15: The method of Clause 14, further comprising: authorizing, by the host server, the transaction based on the transaction ATC value matching the second ATC value.

Clause 16: The method of Clause 14, further comprising: declining, by the host server, the transaction based on the transaction ATC value not matching the second ATC value.

Clause 17: The method of any of Clauses 14-16, further comprising: storing, by the host server, the second ATC value.

Clause 18: The method of any of Clauses 14-17, wherein the transaction authorization request further comprises a cryptogram generated based on the transaction ATC value, the method further comprising: generating, by the host server, a session key based on the transaction ATC value; and validating, by the host server, the cryptogram based on the session key.

Clause 19: The method of Clause 14, wherein the transaction is an offline transaction, wherein the transaction authorization request is a deferred online authorization request, the method further comprising: calculating, by the host server, a set of ATC values, wherein the set of ATC values includes a predetermined number of ATC values, and wherein calculating the set of ATC values comprises sequentially applying an output ATC value calculated by the pseudorandom number generator algorithm as an input ATC value for calculating a next ATC value of the set of ATC values until the predetermined number of ATC values is calculated; and comparing, by the host server, the transaction ATC value to the set of ATC values.

Clause 20: The method of Clause 19, further comprising: authorizing, by the host server, the deferred online authorization request based on the transaction ATC value matching one ATC value from the set of ATC values.

Further, it is understood that any one or more of the following-described forms, expressions of forms, examples, can be combined with any one or more of the other following-described forms, expressions of forms, and examples.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

As used herein, a “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system. Reference to “a server” or “a processor,” as used herein, may refer to a previously recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

As used herein, a “server computer” may describe a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

Reference to “a device,” “a server,” “a processor,” and/or the like, as used herein, may refer to a previously recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

The term “substantially”, “about”, or “approximately” as used in the present disclosure, unless otherwise specified, means an acceptable error for a particular value as determined by one of ordinary skill in the art, which depends in part on how the value is measured or determined. In certain aspects, the term “substantially”, “about”, or “approximately” means within 1, 2, 3, or 4 standard deviations. In certain aspects, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A method for implementing a randomized application transaction counter (ATC) in a payment card transaction, the method comprising:
storing, by a payment card, a first ATC value;
receiving, by the payment card, a request for a cryptogram from an access device, wherein the request is based on a transaction initiated using the payment card and the access device;
calculating, by the payment card, a second ATC value by applying the first ATC value to a pseudorandom number generator algorithm;
generating, by the payment card, the cryptogram based on the second ATC value;
sending, by the payment card, the second ATC value and the cryptogram to the access device; and
storing, by the payment card, the second ATC value.

2. The method of claim 1, wherein calculating the second ATC value by applying the first ATC value to the pseudorandom number generator algorithm comprises applying the first ATC value to a linear congruential generator algorithm.

3. The method of claim 1, where the first ATC value is stored by the payment card based on an issuance of the payment card by an issuer.

4. The method of claim 1, wherein the request is a first request, wherein the transaction is a first transaction, wherein the cryptogram is a first cryptogram, and wherein the access device is a first access device, the method further comprising:
receiving, by the payment card, a second request for a second cryptogram from a second access device, wherein the second request is based on a second transaction initiated using the payment card and the second access device;
calculating, by the payment card, a third ATC value by applying the second ATC value to the pseudorandom number generator algorithm;
generating, by the payment card, the second cryptogram based on the third ATC value;
sending, by the payment card, the third ATC value and the second cryptogram to the second access device; and
storing, by the payment card, the third ATC value.

5. The method of claim 1, wherein generating, by the payment card, the cryptogram based on the second ATC value comprises:
diversifying, by the payment card, a session key based base on the second ATC value; and
generating, by the payment card, the cryptogram based on the session key.

6. The method of claim 1, wherein the transaction is an online transaction, and wherein generating the cryptogram based on the second ATC value comprises generating an authorization request cryptogram (ARQC).

7. A payment card, comprising:
a circuit to:
receive a first request for a first cryptogram, wherein the first request is based on a first transaction initiated using the payment card;
determine a first application transaction counter (ATC) value for use with the first transaction;
generate the first cryptogram based on the first ATC value;
receive a second request for a second cryptogram, wherein the second request is based on a second transaction initiated using the payment card, and wherein the second transaction is the next transaction initiated by the payment card following the first transaction;
determine a second ATC value for use with the second transaction, wherein the second ATC value is not determined by incrementally increasing the first ATC value; and
generate the second cryptogram based on the second ATC value.

8. The payment card of claim 7, wherein the circuit is to:
apply the first ATC value to a pseudorandom number generator algorithm to determine the second ATC value.

9. The payment card of claim 8, wherein the pseudorandom number generator algorithm is a linear congruential generator algorithm.

10. The payment card of claim 8, wherein the circuit is further to:
store an initial ATC value, wherein the initial ATC value is provided by an issuer of the payment card based on issuing the payment card; and
apply the initial ATC value to the pseudorandom number generator algorithm to determine the first ATC value.

11. The payment card of claim 7, wherein the circuit is to:
store a randomized series of ATC values, wherein the randomized series of ATC values includes the first ATC value and the second ATC value, and wherein the randomized series of ATC values is provided by an issuer of the payment card based on issuing the payment card.

12. The payment card of claim 11, wherein the randomized series of ATC values is randomized based on a Fisher-Yates shuffle algorithm.

13. The payment card of claim 7, wherein the circuit is configured according to a Europay Mastercard Visa (EMV) standard.

14. A method for implementing a randomized application transaction counter (ATC) in a payment card transaction, the method comprising:
storing, by a host server, a first ATC value associated with a payment card;
receiving, by the host server, a transaction authorization request, wherein the transaction authorization request comprises a transaction ATC value, and wherein the transaction authorization request is based on a transaction initiated using the payment card;
calculating, by the host server, a second ATC value by applying the first ATC value to a pseudorandom number generator algorithm; and
comparing, by the host server, the transaction ATC value and the second ATC value.

15. The method of claim 14, further comprising:
authorizing, by the host server, the transaction based on the transaction ATC value matching the second ATC value.

16. The method of claim 14, further comprising:
declining, by the host server, the transaction based on the transaction ATC value not matching the second ATC value.

17. The method of claim 14, further comprising:
storing, by the host server, the second ATC value.

18. The method of claim 14, wherein the transaction authorization request further comprises a cryptogram generated based on the transaction ATC value, the method further comprising:
generating, by the host server, a session key based on the transaction ATC value; and
validating, by the host server, the cryptogram based on the session key.

19. The method of claim 14, wherein the transaction is an offline transaction, wherein the transaction authorization request is a deferred online authorization request, the method further comprising:
calculating, by the host server, a set of ATC values, wherein the set of ATC values includes a predetermined number of ATC values, and wherein calculating the set of ATC values comprises sequentially applying an output ATC value calculated by the pseudorandom number generator algorithm as an input ATC value for calculating a next ATC value of the set of ATC values until the predetermined number of ATC values is calculated; and
comparing, by the host server, the transaction ATC value to the set of ATC values.

20. The method of claim 19, further comprising:
authorizing, by the host server, the deferred online authorization request based on the transaction ATC value matching one ATC value from the set of ATC values.
